(19) United States
(12) Patent Application Publication
(10) Pub. No.: US 2013/0209057 A1
(43) Pub. Date: Aug. 15, 2013

(54) METHOD AND APPARATUS FOR CAPTURING AN IMAGE

(71) Applicants: GABI OFIR, RESHON LETZION (IL); BARUH HASON, TEL AVIV-YAFFO (IL); YONI WORTZMAN, RAMAT GAN (IL)

(72) Inventors: GABI OFIR, RESHON LETZION (IL); BARUH HASON, TEL AVIV-YAFFO (IL); YONI WORTZMAN, RAMAT GAN (IL)

(73) Assignee: MOTOROLA SOLUTIONS, INC., Schaumburg, IL (US)

(21) Appl. No.: 13/369,421

(22) Filed: Feb. 9, 2012

(51) Int. Cl. H04N 5/765

(52) U.S. Cl. 386/228; 386/E05.002

(57) ABSTRACT

A method and apparatus are provided for capturing an image so that color degradations can be minimized. During operation, a video-recording system will fetch and record the scene without the illumination of the light bars. More particularly, as a video recorder/transmitter is set to record, logic circuitry triggers the light bars to turn off for a short period of time (e.g., a few seconds), and then turned back on. During that time period, the field-of-vision (unencumbered by the stroboscopic illumination and color) is sampled by the camera as a reference. Color correction/compensation is performed using the unencumbered field-of-vision as a reference.

### FIELD OF THE INVENTION

The present invention relates generally to video capture and in particular to a method and apparatus for capturing an image so that color degradations can be minimized.

### BACKGROUND OF THE INVENTION

The use of cameras by public safety officers to record specifics of accident and crime scenes can facilitate accurate record keeping. The video can be used to objectively determine actual circumstances of critical events such as officer-involved shootings and to investigate allegations of police brutality or other crimes/criminal intent. A common use case entails an officer responding to a call by approaching the scene in their official vehicle having mounted cameras for video capture. Typically, the responding officer's vehicle will have its light bar flashing blue, red, and/or white.

When a video camera is operated near the illumination of light bars, the recorded video suffers color degradations, which change both in time and in space. An automatic white (or color) balance (AWB) mechanisms of conventional video cameras are typically not capable compensating these degradations. In certain cases the illumination coming from the light bars even causes non-required artifacts, which result from wrongly applied AWB. Therefore, a need exists for a method and apparatus for capturing an image so that color degradations can be minimized.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a system for collection and storing video.

FIG. 2 is a block diagram showing the computer of FIG. 1.

FIG. 3 is a flow chart showing operation of the system of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to alleviate the above-mentioned need, a method and apparatus are provided for capturing an image so that color degradations can be minimized. During operation, a video-recording system will fetch and record the scene without the illumination of the light bars. More particularly, as a video recorder/transmitter is set to record, logic circuitry triggers the light bars to turn off for a short period of time (e.g., a few seconds), and then turn back on. During the time period that the light bars are turned off, the field-of-vision (unencumbered by the stroboscopic illumination and color) is sampled by the camera as a reference. Color correction/compensation is performed using the unencumbered field-of-vision as a reference.

The color correction can be accomplished in real time by controlling hardware or software used for recording. In an alternate embodiment, the color correction is performed “off-line” after the video is recorded.

The present invention encompasses a method for capturing an image so that color degradations can be minimized. The method comprising the steps of receiving a video-record trigger, inactivating an external light source on a vehicle based on the received video-record trigger, recording video without the external light source. The video recorded without the external light source will be utilized minimize color degradations.

The present invention additionally encompasses a method for capturing an image so that color degradations can be minimized. The method comprises the steps of receiving a video-record trigger, determining that an external light source on a vehicle is active, and inactivating the external light source on a vehicle when it is active based on the received video-record trigger. Video is recorded without the external light source and utilized minimize color degradations.

The present invention additionally encompasses an automobile comprising a plurality of cameras, a light bar, and a computer that receives a video-record trigger and inactivates the light bar for a predetermined period of time based on the received-video-record trigger.

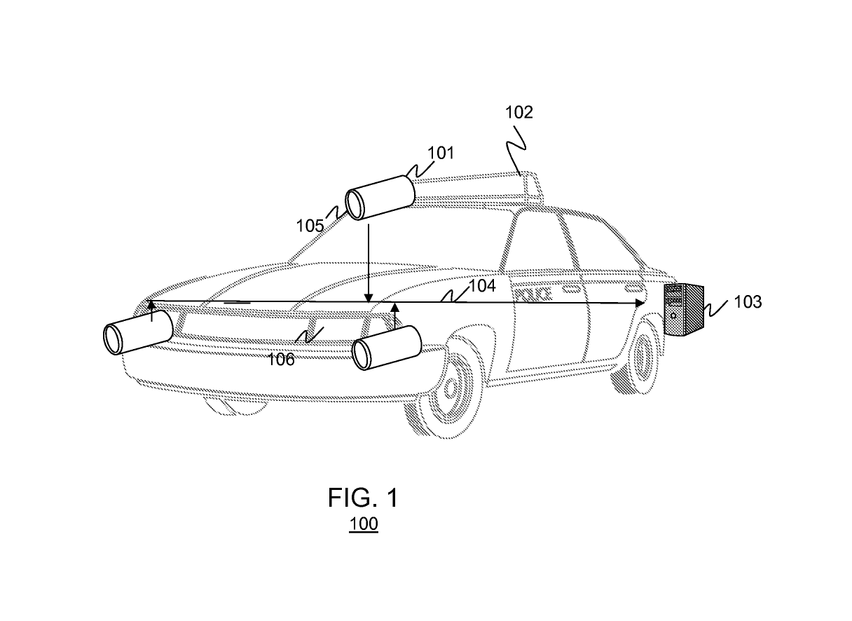

Turning now to the drawings, where like numerals designate like components, FIG. 1 illustrates system 100 for collection and storing of video. As shown, system 100 comprises a plurality of cameras 101 (only one labeled). In one embodiment one or more of the cameras are mounted upon a guidable/remotely positionable camera mounting 105. Computer 103 comprises a simple computer that serves to control camera mounts 105, vehicle rooftop light-bar 102, headlights 106, and/or other vehicle peripheral equipment. Computer 103 also receive, corrects, and stores video from cameras 101. Computer 103 is usually housed in the trunk of the vehicle.

Communication between elements of system 100 is accomplished via bus(es) 104 and/or wirelessly. Although not shown, there may comprise additional wiring such as between computer 103 and camera mounts 105 in order to remotely control camera mount positioning. In a preferred embodiment, system 100 is mounted upon and/or partially within a police patrol automobile, but alternatively may be worn by a police officer.

Each camera mount 105 on the vehicle is assumed to be movable and positionable under the guidance of computer 103. Mount movement could be a linear motion along a single axis or multiple axes (independently or simultaneously) and/or rotary/circular motion. Such motion could trace a combination of unidirectional, reciprocating, oscillating, irregular, and intermittent paths. Movement can be accomplished through use of electric motor(s) or electromechanical actuator(s)/electromagnetic solenoid(s)/relay(s) or pneumatic/air-powered motor(s) or a hybrid of these.

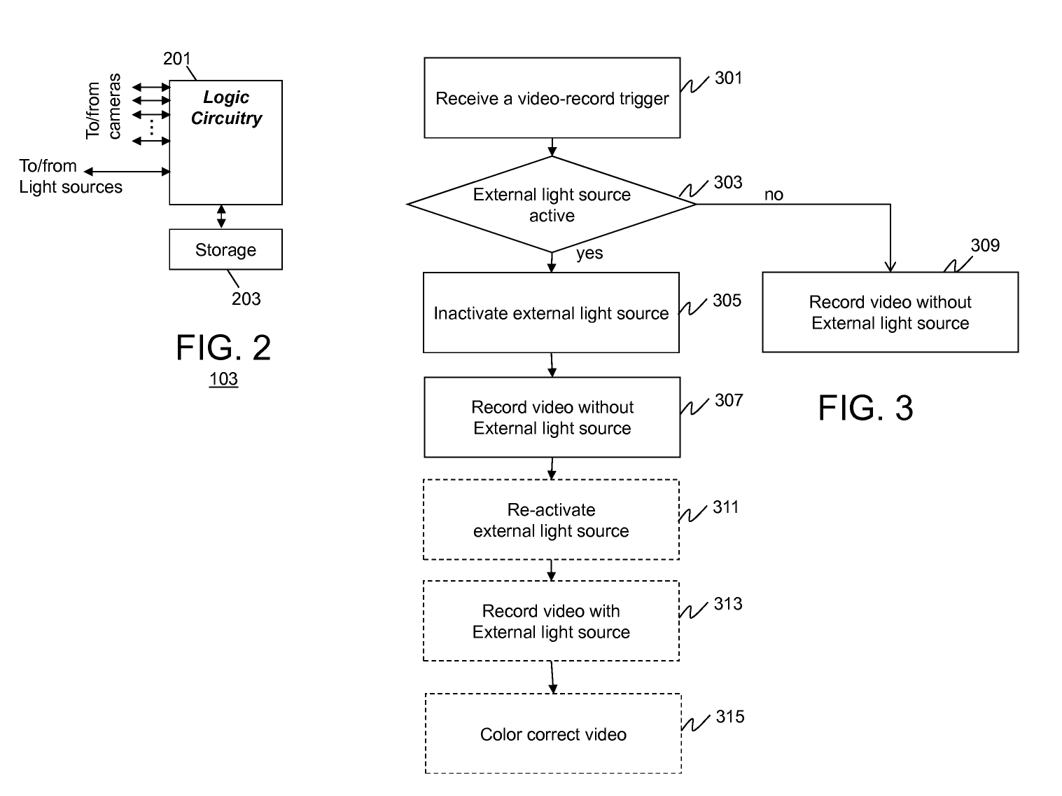

FIG. 2 is a block diagram showing the computer of FIG. 1. As shown, computer 103 comprises logic circuitry 201. Logic circuitry 201 comprises a digital signal processor (DSP), general purpose microprocessor, a programmable logic device, or application specific integrated circuit (ASIC) and is utilized to accesses and control light sources 102 and 106 and cameras 101. Storage 203 comprises standard random access memory and/or non volatile storage medias like SSD or HDD and is used to store/record video received from cameras 101.

During operation logic circuitry 201 receives a recording event and instruct cameras 101 to start video recording. In response, logic circuitry 201 determines if light sources 102 (and possibly 106) are active. If so, logic circuitry 201 instructs light source 102 (and potentially headlights 106) to power down for a predetermined period of time (e.g., 1-3 seconds). During this time period, video is received from at least one camera 101 and stored in storage 203. If needed, logic circuitry 201 will then instruct light source 102 (and potentially headlights 106) to power up. Video will again be received and stored in storage 203. Color correction/compensation can then performed using the unencumbered field-of-vision as a reference. This may take place in real time by logic circuitry 201 continuously correcting received video prior to storage, or alternatively may take place offline by utilizing the video recorded with no light sources powered.

It should be noted that there exist many techniques for correcting received video. For example, the technique used in U.S. Pat. No. 7,394,488B2, entitled “System and Method for Dual White Balance Compensation of Images” may be utilized. Alternatively, the technique described in U.S. Pat No. 7,342,610B2, entitled “Color Balance Adjustment of Image Sensed Upon Emitting Flash Light: may be utilized. However, in a preferred embodiment of the present invention, the following-described technique is utilized for color correction:

In order to appropriately color correct video, a transformation table needs to be created and stored by logic circuitry 201. This can be accomplished prior to operation, or during each instance of recording. Regardless of when the transformation table is created, the table is created by logic circuitry 201 receiving a short duration video clip (reference video) which has been recorded while the disturbing light sources were off. This is stored in storage 203. Logic circuitry 201 then receives a video stream after the disturbing light source is active. The reference video and the video stream are divided into regions for all frames.

For each region in the reference video, logic circuitry 201 computes a color histogram along a recording duration. The colors may be according to RGB (Red Green Blue) or YCrCb (Illumination, red difference, blue difference) or any other complete color definition set. Histograms are then formed by circuitry 201 for each region.

For each region in the video, logic circuitry 201 computes the color histogram along a well defined duration (e.g. 10 frames). The time duration may also be chosen according to the periodicity of the light bars.

For each region and for each color component, logic circuitry 201 reshapes the video histograms such that they approximate the reference histograms. This reshaping action results are stored as a transformation table in storage 203 from color values in the video to the color values to the corrected video.

Further operation of system 100 will transform the color values of video received in each region according to the transformation table derived above. In other words, each region has its own transformation table for each color.

Across the region boundaries, logic circuitry 201 can obtain a smooth transition by smoothing the transformation tables in the region boundaries or by smoothing the corrected values in the region boundaries.

FIG. 3 is a flow chart showing operation of the system of FIG. 1. More particularly, the logic flow of FIG. 3 describes a method for capturing an image so that color degradations can be minimized. As described above, the system of FIG. 1 comprises an automobile having a plurality of cameras, a light bar, headlights, and a computer that receives a video-record trigger and inactivates an external light source (i.e., external from the camera and the computer) for a predetermined period of time based on the received-video-record trigger. The external light source may comprise a light bar 102 such as a standard light bar used by emergency vehicles (e.g., a light bar on top of a police car), and exists as a separate entity from cameras 101. Alternatively, the external light source may comprise vehicle (car) headlights.

The logic flow begins at step 301 where computer 103 receives a video-record trigger. At step 303 a determination is made by computer 103 as to whether or not an external light source on the vehicle is active. As discussed the external light source on the vehicle may comprise a light bar on top of a police car, vehicle headlights, or a combination of both. If the external light source is not active, the logic flow continues to step 309 where the video is simply recorded without the external light source. However, if at step 303 it is determined that the external light source is active, the logic flow continues to step 305 where computer 103 inactivates the external light source on the vehicle based on the received trigger. At step 307 video is recorded without the external light source. As discussed above, the video recorded without the external light source will be utilized minimize color degradations. The logic flow may simply stop here, or continue to optional steps 311-315.

In one embodiment of the present invention, external light sources are pre-programmed to resume operation automatically after a predetermined period of time. However, if the external light source is not pre-programmed to resume operation automatically, computer 103 may activate the external light source (optional step 311) on the vehicle after recording video without the external light source. Video can then be recorded by cameras 101 and computer 103 with the external light source activated (optional step 313). Additionally, computer 103 may color correct the recorded video with the external light source active based on the recorded video without the external light source (optional step 315).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for capturing an image so that color degradations can be minimized, the method comprising the steps of:
receiving a video-record trigger;
inactivating an external light source on a vehicle based on the received video-record trigger; and
recording video without the external light source, wherein the video recorded without the external light source will be utilized minimize color degradations.

2. The method of claim 1 wherein the external light source on the vehicle comprises a light bar on top of a police car.

3. The method of claim 2 wherein the external light source on the vehicle also comprises vehicle headlights.

4. The method of claim 1 wherein the external light source on the vehicle comprises car headlights.

5. The method of claim 1 further comprising the steps of:
activating the external light source on the vehicle after recording video without the external light source; and
recording video with the external light source.

6. The method of claim 5 further comprising the step of:
color-correcting the recorded video with the external light source based on the recorded video without the external light source.

7. A method for capturing an image so that color degradations can be minimized, the method comprising the steps of:
receiving a video-record trigger;
determining that an external light source on a vehicle is active;
inactivating the external light source on a vehicle when it is active based on the received video-record trigger; and
recording video without the external light source, wherein the video recorded without the external light source will be utilized minimize color degradations.

8. The method of claim 7 wherein the external light source on the vehicle comprises a light bar on top of a police car.

9. The method of claim 8 wherein the external light source on the vehicle also comprises vehicle headlights.

10. The method of claim 7 wherein the external light source on the vehicle comprises car headlights.

11. The method of claim 7 further comprising the steps of:
activating the external light source on the vehicle after recording video without the external light source; and
recording video with the external light source.

12. The method of claim 11 further comprising the step of:
color-correcting the recorded video with the external light source based on the recorded video without the external light source.

13. An automobile comprising:
a plurality of cameras;
a light bar; and
a computer that receives a video-record trigger and inactivates the light bar for a predetermined period of time based on the received-video-record trigger.

14. The automobile of claim 13 further comprising:
headlights; and
wherein the computer that receives a video-record trigger and additionally inactivates the headlights for a predetermined period of time based on the received-video-record trigger.

15. The automobile of claim 13 the computer activates the light bar after recording video without the light bar activated and proceeds to record video with the light bar activated.

16. The automobile of claim 15 wherein the computer color-corrects the recorded video with the light bar activated, wherein the color correction is based on the recorded video without the light bar activated.
